(19) United States
(12) Patent Application Publication
(10) Pub. No.: US 2022/0227338 A1
(43) Pub. Date: Jul. 21, 2022

(54) VEHICLE CONTROL SYSTEM

(71) Applicant: HONDA MOTOR CO., LTD., Tokyo (JP)

(72) Inventor: Jasvin PATHEJA, Tokyo (JP)

(21) Appl. No.: 17/574,787

(22) Filed: Jan. 13, 2022

(30) Foreign Application Priority Data
Jan. 20, 2021 (JP) 2021-006902

(51) Int. Cl. B60T 8/1755; B60W 10/18

(52) U.S. Cl. CPC B60T 8/17551; B60W 10/18; B60W 2710/18; B60W 2520/125; B60W 2540/18; B60T 2260/022

(57) ABSTRACT

A vehicle control system with a control device includes an additional deceleration calculation unit, an additional braking force calculation unit that calculates an additional braking force to be generated by a braking force generator according to the additional deceleration, and a control permission determination unit that selectively permits an additional deceleration control that commands the braking force generator to generate the additional braking force at least according to the steering angle, the steering angular velocity, and the lateral acceleration, the control permission determination unit permitting the additional deceleration control when a product of the steering angle and the steering velocity is a positive value, wherein even when the product of the steering angle and the steering velocity is a not positive value, the control permission determination unit permits the additional deceleration control when a product of the steering angle and a differential value of the lateral acceleration is not negative.

### TECHNICAL FIELD

The present invention relates to a vehicle control system that controls a braking force generated by a vehicle braking force generator to improve the handling of the vehicle.

### BACKGROUND ART

In the field of vehicle control systems for improving the yaw response of the vehicle to a steering input at an initial stage of a cornering operation, it is known to apply a deceleration to the vehicle so as to control the attitude (the pitch) of the vehicle as the steering angle of the vehicle increases. See JP2019-142382, for instance. In this vehicle control system, a steering operation is detected from an increase in the absolute value of the steering angle, and a deceleration is applied to the vehicle when a steering operation is detected so that the attitude of the vehicle may be controlled as intended by the vehicle operator. Further, in this vehicle control system, it is determined if the steering velocity is equal to or greater than a prescribed threshold value; an additional acceleration is applied to the vehicle when the steering velocity is equal to or greater than a prescribed threshold value, and this additional acceleration process is canceled when the steering velocity is smaller than the prescribed threshold value. In other words, as soon as the steering angle becomes constant in value, the additional acceleration process is canceled, and no additional deceleration is applied to the vehicle.

However, when the vehicle speed is high, the increase in the lateral acceleration of the vehicle is delayed relative to the increase in the steering angle. In other words, even after the steering angle becomes constant, the lateral force of the front wheels that applies a lateral acceleration to the vehicle and the steer drag given as a component of the lateral force directed rearwardly of the vehicle may continue to increase. When the additional acceleration application process is terminated at such a time, the stability in the attitude of the vehicle may not be improved so much as desired.

### SUMMARY OF THE INVENTION

In view of such a problem of the prior art, a primary object of the present invention is to provide a vehicle control system provided with an attitude control function based on an additional acceleration application process which allows the vehicle attitude to be stabilized when the steering angle of the front wheels becomes constant following a steering maneuver.

To achieve such an object, the present invention provides a vehicle control system (30), comprising: a braking force generator (6, 22) that generates a braking force that acts on a vehicle (1); a control device (31) that controls the braking force generated by the braking force generator; and a vehicle state information acquisition device (33, 34) that acquires vehicle state information including a steering angle (δ) of a front wheel, a steering angular velocity (ω) of the front wheel, and a lateral acceleration (Gy) of the vehicle, wherein the control device includes an additional deceleration calculation unit (43) that calculates an additional deceleration (Gxadd) to be applied to the vehicle according to the vehicle state information, an additional braking force calculation unit (45) that calculates an additional braking force (Fbadd) to be generated by the braking force generator according to the additional deceleration, and a control permission determination unit (46) that selectively permits an additional deceleration control that commands the braking force generator to generate the additional braking force at least according to the steering angle (δ), the steering angular velocity (ω), and the lateral acceleration (Gy), the control permission determination unit permitting the additional deceleration control when a product of the steering angle (δ) and the steering angular velocity (ω) is a positive value (δ·ω>0), wherein even when the product of the steering angle and the steering angular velocity is not a positive value (δ·ω≤0), the control permission determination unit permits the additional deceleration control when a product of the steering angle (δ) and a differential value of the lateral acceleration (d/dt Gy) is not negative (δ·d/dt Gy≥0) in value.

Since the control permission determination unit permits the additional deceleration control when the product of the steering angle and the steering angular velocity is positive as well as when the product of the steering angle (δ) and the steering velocity is positive, the additional deceleration control is permitted when the front wheels are being steered in either direction, and, typically, otherwise prohibiting the additional deceleration control (such as when the front wheels are being returned to the neutral position). As a result, unnecessary additional deceleration is prevented from being generated. Further, even if the product of the steering angle and the steering angular velocity is not positive, the control permission determination unit permits the additional deceleration control when the product of the steering angle and the differential value of the lateral acceleration is not negative. As a result, when the front wheels are steered and fixed at a constant steering angle, the additional deceleration control continues to be permitted so that the attitude of the vehicle can be kept stable even after the steering angle is kept constant.

Preferably, when the additional deceleration control continues to be permitted because the product of the steering angle and the differential value of the lateral acceleration (δ·d/dt Gy) is positive in value following an event where the product of the steering angle and the steering angular velocity (δ·ω) changes from being positive in value to being not positive in value, the control permission determination unit (46) prohibits the additional deceleration control upon elapsing of a prescribed extension time (T) depending on a vehicle speed (V) from a time point at which the product of the steering angle and the steering angular velocity (δ·ω) changes from being positive in value to being not positive in value.

An increase in the lateral acceleration owing to an increase in the steering angle occurs with a certain time delay which changes with the vehicle speed. According to this aspect of the present invention, the additional deceleration is permitted to continue after the cessation of the increase in the steering angle for the extension time.

Preferably, the extension time (T) becomes longer with an increase in the vehicle speed.

The delay in the increase in the lateral acceleration with respect to the increase in the front wheel steering angle increases. Therefore, by increasing the extension time with an increase in the vehicle speed, the attitude of the vehicle can be stabilized in a more favorable manner.

Preferably, the control permission determination unit (46) selectively permits the additional deceleration control according to the steering angular velocity (ω) which is subjected to a dead zone process.

Even when the vehicle is traveling straight ahead or performing a steady cornering, the steering velocity may minutely fluctuate due to road surface irregularities and other causes. According to this aspect of the present invention, the additional deceleration control is prevented from being unnecessarily permitted when no additional deceleration control is required such as when traveling straight ahead and cornering at a constant turning radius.

Preferably, the control device further comprises a steer drag differential value calculation unit (42) that calculates a steer drag differential value (d/dt GxD) by differentiating a steer drag value (GxD) obtained from the vehicle state information as a rearward directed component of a lateral force of the front wheel of the vehicle, and the additional deceleration calculation unit (43) calculates the additional deceleration according to the steer drag differential value.

The steer drag differential value is generated with a phase advance of 90° with respect to the steer drag. According to this aspect of the present invention, since the additional deceleration calculation unit calculates the additional deceleration based on the steer drag differential value, the additional deceleration is generated with a phase advance with respect to the generation of the steer drag. As a result, the load of the vehicle is transferred to the front wheels at an early stage during a cornering so that the cornering performance of the vehicle is improved. Further, by generating the additional deceleration based on the steer drag differential value when the steer drag is increasing after the steering angle has become constant, the load transfer to the front wheel is appropriately performed so that the vehicle attitude can be stabilized.

Preferably, the vehicle state information acquisition device further comprises a velocity sensor (35) that detects an angular velocity or a velocity corresponding to the steering angular velocity (δ·ω), and the control device (31) further comprises a control lateral acceleration calculation unit (41) that calculates a control lateral acceleration (Gy) by using at least the steering angular velocity, the additional deceleration calculation unit (43) calculating the steer drag differential value by using the control lateral acceleration.

Since the control lateral acceleration calculation unit uses the steering angular velocity instead of the time differentiated value of the steering angle to calculate the control lateral acceleration, the formula for the control lateral acceleration calculation may consist of a relatively low order equation. Also, in case the control device fails to acquire information on the steering angle in the current control cycle, and holds the previous value for the current control cycle, the differential value may fluctuate to an unacceptably significant extent. However, since the formula for the control lateral acceleration is a relatively low order equation, such fluctuations in the control lateral acceleration due to information discontinuity can be minimized.

Preferably, the braking force generator includes a brake device (22), and the additional braking force calculation unit (45) calculates at least a part of the additional braking force (Fbadd) to be commanded to the brake device.

Thereby, the braking device can apply an additional braking force to the vehicle with a high responsiveness. Furthermore, when steering the vehicle to a straight ahead traveling condition following a cornering operation, unnecessary control intervention can be avoided so that the durability of the brake device is prevented from being impaired.

Thus, the vehicle control system of the present invention is provided with an attitude control function based on an additional acceleration application process which allows the vehicle attitude to be stabilized when the steering angle of the front wheels becomes constant following a steering maneuver.

### BRIEF DESCRIPTION OF THE DRAWING(S)

FIG. 1 is a block diagram of a vehicle equipped with a vehicle control system according to an embodiment of the present invention;

FIG. 2 is a functional block diagram of a control device included in the vehicle control system:

FIG. 3 is a time chart showing a mode of operation of the control device;

FIG. 4 is a functional block diagram of a control lateral acceleration calculation unit of the control device;

FIG. 5 is a time chart of various lateral accelerations at a certain vehicle speed;

FIG. 6 is a time chart of various parameters showing a mode of calculating the control lateral acceleration;

FIG. 7 is a functional block diagram of a steer drag differential value calculation unit of the control device;

FIG. 8 is a functional block diagram of an additional deceleration calculating unit of the control device;

FIG. 9 is a functional block diagram of a control permission determination unit of the control device;

FIG. 10 is a time chart showing the changes in various parameters when the vehicle is traveling at a low speed;

FIG. 11 is a time chart showing the changes in various parameters when the vehicle is traveling at a high speed; and

FIG. 12 is a time chart showing the changes in various parameters when the vehicle is traveling at a high speed according to an additional deceleration control based on prior art.

### DESCRIPTION OF THE PREFERRED EMBODIMENT(S)

A vehicle control system 30 according to an embodiment of the present invention is described in the following with reference to the appended drawings.

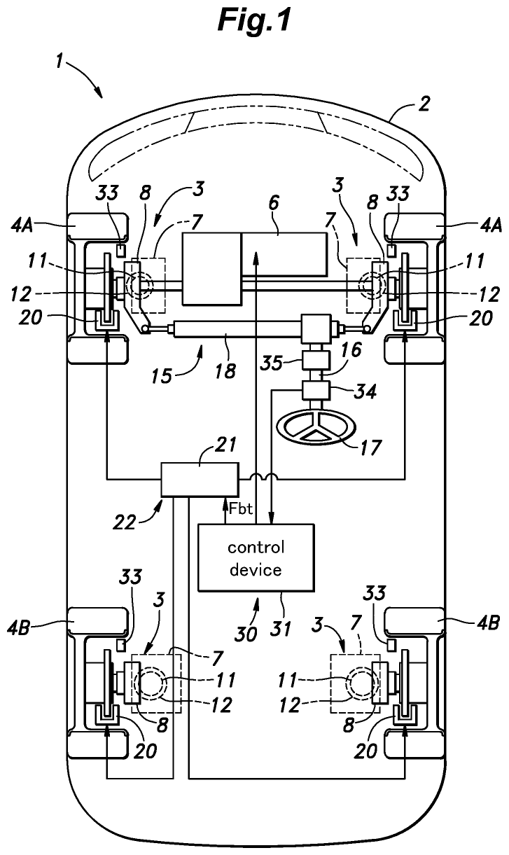

FIG. 1 is a schematic diagram of the structure of a vehicle 1 fitted with a vehicle control system 30 according to the present embodiment. As shown in FIG. 1, the vehicle 1 of this embodiment consists of a four-wheeled vehicle including a vehicle body 2 forming the structural frame of the vehicle 1 supporting a pair of front wheels 4A and a pair of rear wheels 4B via respective suspension devices 3.

The vehicle 1 is provided with a power plant 6 that drives the wheels 4 (4A, 4B). The power plant 6 may consist of at least one of an internal combustion engine such as a gasoline engine and a diesel engine and an electric motor. The vehicle 1 of the present embodiment is a front-wheel drive vehicle in which the power plant 6 is a gasoline engine and the driving force and braking force (rotational resistance) of the power plant 6 are transmitted to the front wheels 4A. The power plant 6 is a driving force generating device that generates the driving force that acts on the vehicle 1, and is also a braking force generating device that generates a braking force that acts on the vehicle 1. Alternatively, the vehicle 1 may be a four-wheel drive vehicle or a rear-wheel drive vehicle.

Each suspension device 3 includes a suspension arm 7 pivotally supported by the vehicle body 2, a knuckle 8 supported by the suspension arm 7 to rotatably support the front wheel 4A or the rear wheel 4B, and a spring 11 and a damper 12 provided between the vehicle body 2 and the suspension arm 7.

The vehicle 1 is provided with a steering device 15 that steers the front wheels 4A. The steering device 15 includes a steering shaft 16 rotatably supported by the vehicle body 2 around an axis thereof, a steering wheel 17 provided at the upper end of the steering shaft 16, a pinion provided at the lower end of the steering shaft 16, and a rack 18 extending laterally and meshing with the pinion. The two ends of the rack 18 are connected to left and right knuckles 8 via tie rods, respectively. When the steering wheel 17 connected to the steering shaft 16 is turned, the rack 18 moves laterally in the corresponding direction, causing the front wheels 4A to be steered via the corresponding knuckles 8. Further, the steering shaft 16 is fitted with an electric motor that applies assist torque to the steering shaft 16 in response to a steering input from the driver.

Each of the front wheels 4A and the rear wheels 4B is provided with a brake device 20. The brake device 20 may consist of a disc brake device which is configured to generate a braking force on the corresponding wheel 4A, 4B by means of the oil pressure supplied from an oil pressure supply device 21. A brake system 22 is formed by the brake devices 20 of the different wheels and the oil pressure supply device 21. The brake system 22 is a braking force generating system that generates a braking force acting on the vehicle 1. The oil pressure supply device 21 is configured to independently control the hydraulic pressure supplied to each brake device 20 so that the braking forces applied to the front wheels 4A and the rear wheels 4B of the brake system 22 can be changed independently of each other.

The vehicle 1 is provided with a vehicle control system 30 that controls the behavior of the vehicle 1. The vehicle control system 30 includes a control device 31 as a main part thereof. The control device 31 is essentially an electronic control circuit (ECU) composed of a microcomputer, ROM, RAM, a peripheral circuit, an input/output interface, various drivers, and the like. The control device 31 is connected to the power plant 6, the oil pressure supply device 21, and various sensors so as to be able to exchange signals via a communication means such as CAN (Controller Area Network).

The vehicle body 2 is provided with an accelerator pedal sensor that detects the amount of operation of the accelerator pedal and a brake pedal sensor that detects the amount of operation of the brake pedal. The control device 31 executes multiple control operations. In one of these control operations, a target braking force Fbt to be generated by the brake system 22 is calculated from the operation amount of the brake pedal, and an oil pressure supply device 21 is controlled according to the target braking force Fbt. In another control operation, the control device 31 controls the power plant 6 based on the operation amount of the accelerator pedal.

The control device 31 calculates an additional deceleration Gxadd to be added or applied to the vehicle 1 based on the vehicle state amounts representing the dynamic state of the vehicle 1 regardless of the driver's accelerator pedal operation and brake pedal operation, and controls at least one of the brake system 22 and the power plant 6 so as to generate an additional braking force Fbadd corresponding to the additional deceleration Gxadd. The vehicle state amounts include the vehicle speed V, which is the speed of the vehicle 1, the front wheel steering angle δ, which is the steering angle of the front wheels 4A, the front wheel steering angular velocity ω, which is the steering angular velocity of the front wheels 4A, and the like.

The vehicle body 2 is provided with vehicle speed sensors 33, a front wheel steering angle sensor 34, and a front wheel steering angular velocity sensor 35 as vehicle state amount detection devices. Each of the front wheels 4A and the rear wheels 4B is provided with the corresponding vehicle speed sensor 33 which outputs a pulse signal generated in response to the rotation of the corresponding wheel 4A, 4B to the control device 31. The control device 31 acquires the wheel speeds of the front wheels 4A and the rear wheels 4B based on the signals from the vehicle speed sensors 33, and acquires the vehicle speed V by averaging the wheel speeds of the different wheels. The vehicle speed V is acquired as a positive value when moving forward and as a negative value when moving backward.

The front wheel steering angle sensor 34 outputs a signal corresponding to the rotational angle of the steering shaft 16 (steering wheel steering angle) to the control device 31. The control device 31 converts the rotational angle input from the front wheel steering angle sensor 34 into a rotational angle of the front wheels 4A (front wheel steering angle), which are the steered wheels, by multiplying the steering wheel steering angle by a predetermined gear ratio, and acquires the front wheel steering angle δ. The front wheel steering angle δ is acquired as a positive value during a left turn operation and as a negative value during a right turn operation.

The front wheel steering angular velocity sensor 35 outputs a signal corresponding to the rotational angular velocity (steering wheel steering angular velocity) of the steering shaft 16 to the control device 31. The control device 31 converts the angular velocity input from the front wheel steering angular velocity sensor 35 into the steering angular velocity of the front wheels 4A (front wheel steering angular velocity), which are the steered wheels, by multiplying the angular velocity input from the front wheel steering angular velocity sensor 35 by a predetermined gear ratio, and acquires the front wheel steering angular velocity ω. The front wheel steering angular velocity ω is acquired as a positive value during a leftward turning operation and as a negative value during a rightward turning operation. The front wheel steering angular velocity ω is a time differentiated value of the front wheel steering angle δ and is represented by d/dt δ. Hereinafter, in mathematical formulas and drawings, d/dt may be represented by a dot placed above the variable. In this particular case, the front wheel steering angular velocity ω is obtained not a value calculated by time-differentiating the front wheel steering angle δ, but as a speed detection value corresponding to the angular velocity output from the front wheel steering angular velocity sensor 35.

In another embodiment, the front wheel steering angle sensor 34 detects the stroke of the rack 18 in the lateral direction, and the control device 31 multiplies the stroke input from the front wheel steering angle sensor 34 by a predetermined coefficient to obtain the front wheel steering angle δ. Further, it may be arranged such that the front wheel steering angular velocity sensor 35 detects the stroke speed of the rack 18 in the lateral direction, and the control device 31 multiplies the stroke speed input from the front wheel steering angle sensor 34 by a predetermined coefficient to obtain the steering angular velocity of the front wheels 4A. The front wheel steering angular velocity is thus detected as a value corresponding to the linear stroke velocity of the rack 18.

The control device 31 serves as a vehicle speed acquisition device that acquires the vehicle speed V in cooperation with the vehicle speed sensors 33, a front wheel steering angle acquisition device that acquires the front wheel steering angle δ in cooperation with the front wheel steering angle sensor 34, and a front wheel steering angular velocity acquisition device that acquires the front wheel steering angular velocity ω in cooperation with the front wheel steering angular velocity sensor 35.

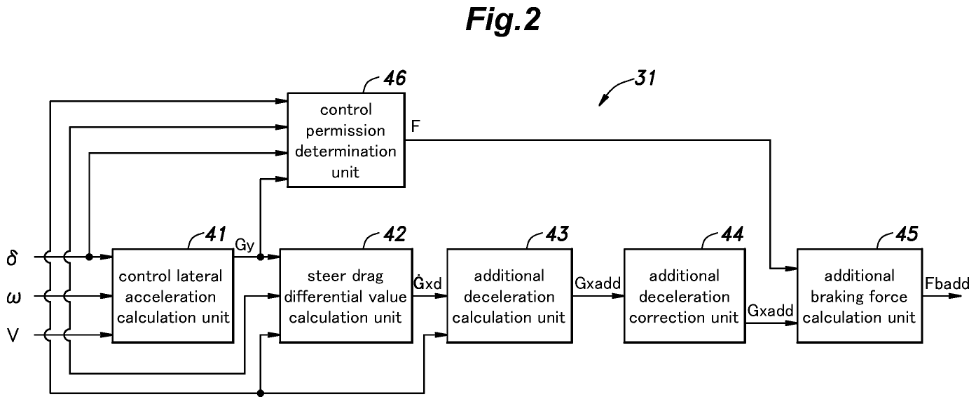

As shown in FIG. 2, the control device 31 includes a control lateral acceleration calculation unit 41, a steer drag differential value calculation unit 42, an additional deceleration calculation unit 43, an additional deceleration correction unit 44, and an additional braking force calculation unit 45. The control lateral acceleration calculation unit 41 calculates a control lateral acceleration Gy used for an additional deceleration control (which will be discussed hereinafter) based on the front wheel steering angle δ, the front wheel steering angular velocity ω, and the vehicle speed V. The steer drag differential value calculation unit 42 calculates a steer drag differential value d/dt GxD obtained by time differentiating a steer drag GxD, which is a component of the lateral force of the front wheels 4A directed rearward of the vehicle 1, obtained from the control lateral acceleration Gy, the front wheel steering angle δ, and the front wheel steering angular velocity ω. The additional deceleration calculation unit 43 calculates an additional deceleration Gxadd to be applied to the vehicle 1 according to the steer drag differential value d/dt GxD. The additional deceleration correction unit 44 corrects the additional deceleration Gxadd according to various vehicle state amounts. The additional braking force calculation unit 45 calculates the additional braking force Fbadd to be generated in the power plant 6 and/or the brake system 22 based on the corrected additional deceleration Gxadd. By operating these functional units, the control device 31 executes an additional deceleration control to generate a braking force acting on the vehicle 1 from the power plant 6 and/or the brake system 22.

The control permission determination unit 46 selectively permits an additional deceleration control that commands the power plant 6 and/or the brake system 22 to generate an additional braking force Fbadd according to the front wheel steering angle δ, the front wheel steering angular velocity ω, the vehicle speed V, and the lateral acceleration Gy, and generates a control permission flag F indicating the result of selection or determination if an additional deceleration control is to be permitted or not. The control permission flag F is set to 1 when the additional deceleration control is permitted, and is set to 0 when the additional deceleration control is not permitted. The additional braking force calculation unit 45 outputs the additional braking force Fbadd only when the control permission flag F is 1, and the additional deceleration control is therefore permitted. The control device 31 executes the additional deceleration control so that a braking force acting on the vehicle 1 is generated in the power plant 6 and/or the brake system 22 by activating or operating the corresponding functional units.

In this way, the control device 31 calculates the additional braking force Fbadd based on the front wheel steering angle δ, the front wheel steering angular velocity ω and the vehicle speed V, and executes the additional deceleration control whereby the braking force to be applied to the vehicle 1 is generated by the power plant 6 and/or the brake system 22. This control process is executed by the control device 31 without using the actual lateral acceleration of the vehicle 1 detected by a lateral acceleration sensor. As a result, the control lateral acceleration Gy can be advanced in phase with respect to the actual lateral acceleration so that the additional deceleration Gxadd can be generated in the vehicle 1 earlier than when the actual lateral acceleration is used. Therefore, it is possible to reduce a time delay of the additional deceleration Gxadd that could be caused by the communication delay in acquiring the sensor information, the communication delay of the target braking force information, and the response delay of the braking force generator.

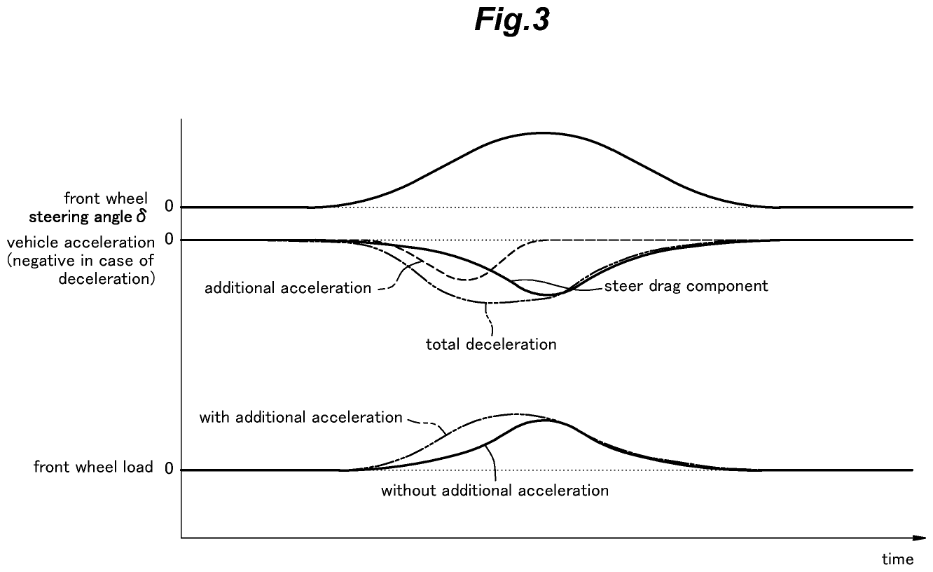

FIG. 3 is a time chart showing the working principle of the additional deceleration control executed by the control device 31. As shown in FIG. 3, when the steering wheel 17 is operated and the front wheel steering angle δ increases, a traveling resistance (steer drag GxD) is created in the front wheels 4A, and as shown by the solid lines, the vehicle 1 decelerates by an amount corresponding to the amount of the steer drag (due to this steer drag GxD). The deceleration of the vehicle 1 causes the front wheel load of the vehicle 1 to be increased in a corresponding amount. The deceleration of the vehicle 1 or the increase in the front wheel load corresponding to the steer drag occurs with some time delay relative to the increase of the front wheel steering angle δ. Thus, there is some response delay between the steering of the front wheels 4A and the resultant increase in the steer drag.

On the other hand, the steer drag differential value d/dt GxD is advanced in phase relative to the steer drag GxD by 90°. Therefore, when the additional deceleration calculation unit 43 calculates the additional deceleration Gxadd based on the steer drag differential value d/dt GxD, and the control device 31 generates the additional braking force Fbadd based on this calculated steer drag differential value d/dt GxD, the additional deceleration Gxadd is additionally applied to the vehicle 1 in such a manner that the total deceleration of the vehicle 1 is advanced in phase relative to the deceleration component due to the steer drag as shown by the imaginary line in FIG. 3. As a result, the front wheel load starts increasing with an advanced phase as compared with the case where no additional deceleration Gxadd is applied so that the cornering performance of the vehicle 1 is improved.

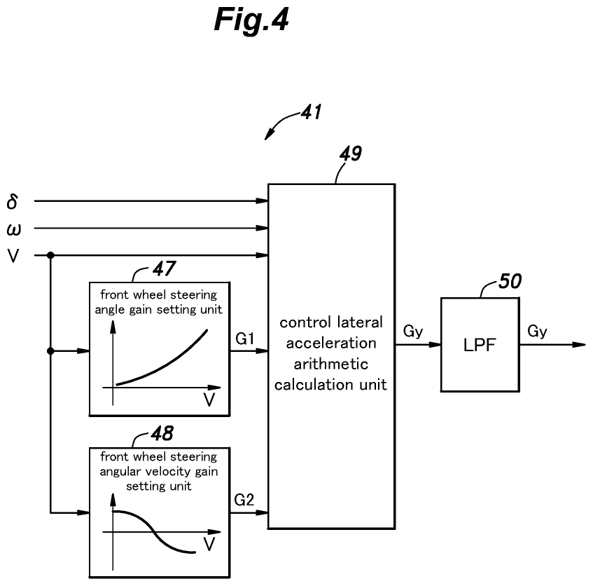

As shown in FIG. 4, the control lateral acceleration calculation unit 41 includes a front wheel steering angle gain setting unit 47, a front wheel steering angular velocity gain setting unit 48, a control lateral acceleration arithmetic calculation unit 49, and a low-pass filter (hereinafter referred to as LPF 50). The front wheel steering angle gain setting unit 47 sets a front wheel steering angle gain G1 which is a first correction value with respect to the front wheel steering angle δ used for calculating the control lateral acceleration Gy based on the vehicle speed V. The front wheel steering angular velocity gain setting unit 48 sets a front wheel steering angular velocity gain G 2 which is a second correction value for the front wheel steering angular velocity ω used for calculating the control lateral acceleration Gy based on the vehicle speed V. The control lateral acceleration arithmetic calculation unit 49 calculates the control lateral acceleration Gy based on the front wheel steering angle δ, the front wheel steering angular velocity ω, the front wheel steering angle gain G1, and the front wheel steering angular velocity gain G2.

The front wheel steering angle gain setting unit 47 is provided with a front wheel steering angle gain map defining the relationship between the vehicle speed V and the front wheel steering angle gain G1 such that the desired characteristics of the responsiveness of the lateral acceleration to the front wheel steering angle δ, which changes according to the vehicle speed V, may be achieved. The front wheel steering angle gain setting unit 47 extracts a value corresponding to the vehicle speed V from the front wheel steering angle gain map, and sets the extracted value as the front wheel steering angle gain G1.

The front wheel steering angular velocity gain setting unit 48 is provided with a front wheel steering angular velocity gain map defining the relationship between the vehicle speed V and the front wheel steering angular velocity gain G2 such that the desired characteristics of the responsiveness of the lateral acceleration to the front wheel steering angular velocity ω, which changes according to the vehicle speed V, may be achieved. The front wheel steering angular velocity gain setting unit 48 extracts a value corresponding to the vehicle speed V from the front wheel steering angular velocity gain map, and sets the extracted value as the front wheel steering angular velocity gain G2.

The control lateral acceleration arithmetic calculation unit 49 calculates the control lateral acceleration Gy by calculating Equation (1) given below:

G_{y}=G1·δ+G2·ω (1)

Thus, the control lateral acceleration arithmetic calculation unit 49 calculates the first multiplication value (the first multiplication value of Equation (1)) by multiplying the front wheel steering angle δ by the front wheel steering angle gain G1 which is the first correction value based on the vehicle speed V, calculates the second multiplication value (the second multiplication value of Equation (1)) by multiplying the front wheel steering angular velocity ω by the front wheel steering angular velocity gain G2, which is the second correction value based on the vehicle speed V, and calculates the control lateral acceleration Gy by adding the first multiplication value and the second multiplication value to each other. By calculating the control lateral acceleration Gy in this way by using the control lateral acceleration calculation unit 41, the contribution of the control lateral acceleration Gy to the lateral acceleration of the vehicle 1 is caused to change with the vehicle speed V in such a manner that the response of the actual lateral acceleration to the steering operation changes with the vehicle speed V in an optimum fashion.

When calculating the control lateral acceleration Gy, the control lateral acceleration arithmetic calculation unit 49 uses the front wheel steering angular velocity ω acquired from the front wheel steering angular velocity sensor 35, instead of the time differential value of the front wheel steering angle δ acquired from the front wheel steering angle sensor 34. Thereby, Equation (1) used for calculating the control lateral acceleration Gy is prevented from being one of a higher order. As a result, calculation delay in the control device 31 can be minimized so that the control lateral acceleration Gy can be calculated in a more appropriate manner. Further, when the control device 31 holds the previous value (the value obtained in the previous control cycle) because of a failure to obtain the current steering angle information from the sensor, the steering angular velocity value is prevented from changing in an oscillatory manner. This topic will be discussed in a greater detail hereinafter.

The LPF 50 performs a low-pass filter process on the control lateral acceleration Gy calculated by the control lateral acceleration arithmetic calculation unit 49. As a result, the increase in the high frequency gain is suppressed so that undue fluctuations of the control lateral acceleration Gy in a high frequency region is prevented, and the noise in the control lateral acceleration Gy is substantially eliminated. By performing the low-pass filter process on the control lateral acceleration Gy by using the control lateral acceleration calculation unit 41 in this way, it becomes possible to apply a stable braking force to the vehicle 1.

The control lateral acceleration arithmetic calculation unit 49 calculates the control lateral acceleration Gy by using Equation (1) based on the front wheel steering angle δ, the front wheel steering angular velocity ω, and the vehicle speed V in this way. Therefore, the phase of the control lateral acceleration Gy can be advanced as compared with the conventional technique of calculating the control lateral acceleration Gy by using a planar two degrees of freedom model, and the additional deceleration Gxadd can be generated in the vehicle 1 at an early stage. This action and the effect thereof are discussed in the following in greater detail. In the following discussion, the conventional lateral acceleration calculated by using the planar two degrees of freedom model will be referred to as a conventional model lateral acceleration Gyc to distinguish it from the control lateral acceleration Gy of the present embodiment.

The conventional model lateral acceleration Gyc calculated by using the planar two degrees of freedom model of the vehicle 1 (the reference model disclosed in JP 6395789B) can be represented by Equation (2) given below.

$${G}_{yc} = V ( \frac{d}{dt} β + r ) \qquad ( 2 )$$

where β is the vehicle body slip angle at the center of gravity, and r is the yaw rate around the center of gravity of the vehicle 1. Equation (2) may be expressed as Equation (3) given below by using the Laplace operator s.

G_{yc}(s)=Vsβ(s)+Vr(s) (3)

Equation (3) can also be represented as Equation (4) given below by using the transfer function of the vehicle body slip angle β with respect to the front wheel steering angle δ, the transfer function of the yaw rate r with respect to the front wheel steering angle δ, and the front wheel steering angle δ.

G_{yc}(s)=VsG_{δ}^{β}(s)δ(s)+VG_{δ}^{r}(s)δ(s) (4)

The vehicle body slip angle β(s) in Equation (3) is given as in Equation (5) below.

β(s)=G_{δ}^{β}(s)δ(s) (5)

The transfer function of the vehicle body slip angle β with respect to the front wheel steering angle δ in Equation (5) is expressed by Equation (6) given below.

$${G}_{δ}^{β} ( s ) = {G}_{δ}^{β} ( 0 ) \frac{1 + {T}_{β} s}{1 + \frac{2 ζ s}{{ω}_{n}} + \frac{{s}^{2}}{{ω}_{n}^{2}}} \qquad ( 6 )$$

where G_{δ}^{β}(0): steady state vehicle body slip angle gain
T_{β}: vehicle body slip angle advance time constant
ωₙ: characteristic frequency
ζ: damping factor

The yaw rate r(s) in the formula of Equation (3) is as shown in Equation (7) given below.

r(s)=G_{δ}^{r}(s)δ(s) (7)

The transfer function of the yaw rate r with respect to the front wheel steering angle δ in Equation (7) can be expressed by Equation (8) given below.

$${G}_{δ}^{r} ( s ) = {G}_{δ}^{r} ( 0 ) \frac{1 + {T}_{r} s}{1 + \frac{2 ζ s}{{ω}_{n}} + \frac{{s}^{2}}{{ω}_{n}^{2}}} \qquad ( 8 )$$

where G_{δ}^{γ}(0): steady state yaw rate gain
T_{γ}: yaw rate advance time constant

Equation (4) can be rewritten as in Equation (9) by substituting the above equations (6) and (8) thereinto.

$${G}_{yc} ( s ) = {VsG}_{δ}^{β} ( 0 ) \frac{1 + {T}_{β} s}{1 + \frac{2 ζ s}{{ω}_{n}} + \frac{{s}^{2}}{{ω}_{n}^{2}}} δ ( s ) + {VG}_{δ}^{r} ( 0 ) \frac{1 + {T}_{r} s}{1 + \frac{2 ζ s}{{ω}_{n}} + \frac{{s}^{2}}{{ω}_{n}^{2}}} δ ( s ) \qquad ( 9 )$$

The product of the steady state yaw rate gain Gδr (0) and the vehicle speed V coincides with the steady state lateral acceleration gain as shown Equation (10) given below

G_{≡}^{r}(0 )=VG_{β}^{r}(0) (10)

Therefore, Equation (9) can be expressed as shown in Equation (11) given below by substituting Equation (10) thereinto.

$${G}_{yc} ( s ) = {VG}_{δ}^{β} ( 0 ) ( \frac{1 + {T}_{β} s}{1 + \frac{2 ζ s}{{ω}_{n}} + \frac{{s}^{2}}{{ω}_{n}^{2}}} ) s δ ( s ) + {G}_{δ}^{\hat{y}} ( 0 ) ( \frac{1 + {T}_{r} s}{1 + \frac{2 ζ s}{{ω}_{n}} + \frac{{s}^{2}}{{ω}_{n}^{2}}} ) δ ( s ) \qquad ( 11 )$$

The denominator part in parentheses in each of the first term and the second term of Equation (11) represents a second-order delay component which is determined by the vehicle specifications. Further, the vehicle body slip angle advance time constant (T) of the numerator of the part in parentheses in the first term of Equation (11) is a differential component which is determined by the vehicle specifications. Further, the yaw rate advance time constant (Tr) of the numerator of the part in parentheses in the second term of Equation (11) is a differential component which is determined by the vehicle specifications. In the first term of the above equation (11), the product of the front wheel steering angle δ(s) and the Laplace operator s represents a differential component of the front wheel steering angle δ(s).

Thus, the control lateral acceleration Gy represented by Equation (1) given above can be approximated by Equation (11) by disregarding or ignoring the second-order delay component and the differential component which are determined by the specifications of the vehicle 1.

Based on such a consideration, the control lateral acceleration calculation unit 41 calculates the control lateral acceleration Gy which is advanced in phase with respect to the conventional model lateral acceleration Gyc by ignoring the second-order delay component determined by the vehicle specifications from the conventional model lateral acceleration Gyc which is obtained by using the planar two degrees of freedom model based on the vehicle state information. Thereby, as shown in FIG. 2, the control device 31 calculates the additional braking force Fbadd based on the control lateral acceleration Gy that is advanced in phase so that the delay due to the second-order delay component is suppressed, and the additional deceleration (braking force) can be applied to the vehicle 1 at an appropriate timing.

The differential components which are determined by the vehicle specifications are ignored or disregarded because they have a small influence on the control lateral acceleration Gy. Also by ignoring these differential components, the control lateral acceleration Gy can be advanced in phase with respect to the conventional model lateral acceleration Gyc obtained by using the planar two degrees of freedom model.

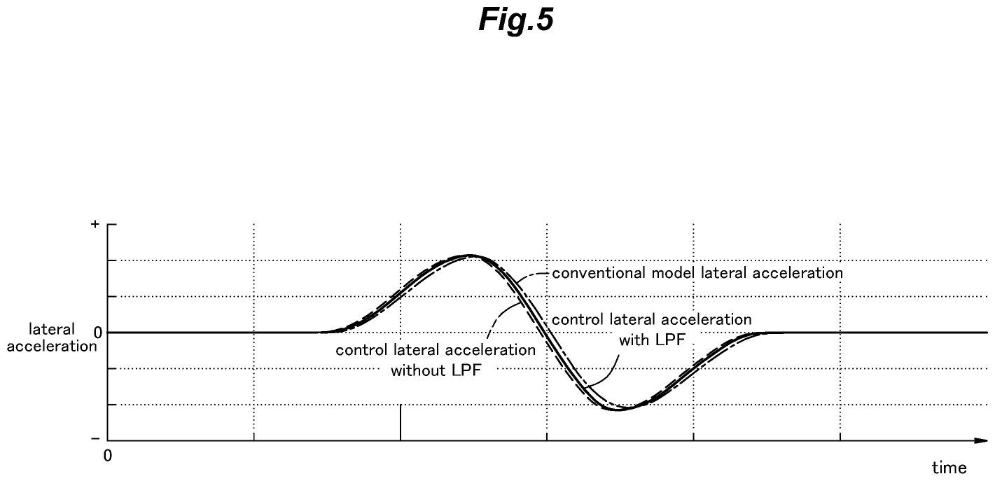

FIG. 5 is a time chart of various lateral accelerations calculated at a certain vehicle speed. The various lateral accelerations (the three lateral accelerations) include the conventional model lateral acceleration Gyc calculated by using the planar two degrees of freedom model, the control lateral acceleration Gy calculated by using the control lateral acceleration arithmetic calculation unit 49, and the control lateral acceleration Gy which is additionally subjected to the filtering process by the LPF50.

As shown in FIG. 5, when the steering wheel 17 is steered to the left or right, the conventional model lateral acceleration Gyc becomes a positive value and then a negative value. The control lateral acceleration Gy calculated by the control lateral acceleration arithmetic calculation unit 49 is advanced in phase relative to the conventional model lateral acceleration Gyc. The control lateral acceleration Gy which is additionally subjected to the filtering process by the LPF 50 is somewhat delayed in phase as compared with the control lateral acceleration Gy without filtering, but is well ahead of the conventional model lateral acceleration Gyc in phase.

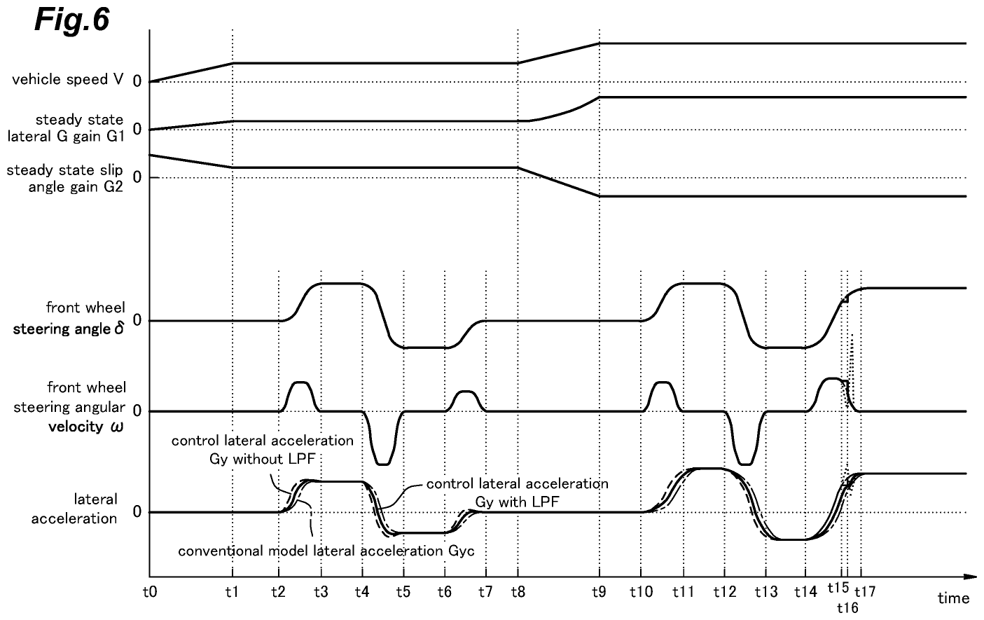

FIG. 6 is a time chart showing a calculation example of the control lateral acceleration Gy. As shown in FIG. 6, the value of the front wheel steering angle gain G1 and the value of the front wheel steering angular velocity gain G2 both change during the intervals between the time point t0 and the time point t1, and between the time point t8 and the time point t9 due to the changes in the vehicle speed V. More specifically, the front wheel steering angle gain G1 increases as the vehicle speed V increases. The front wheel steering angular velocity gain G2 decreases as the vehicle speed V increases, and may even become a negative value when the vehicle speed V is equal to or higher than a predetermined value.

The front wheel steering angle δ increases from 0 during the time interval between the time point t2 and the time point t3, decreases to a negative value during the time interval between the time point t4 and the time point t5, and increases again back to value 0 during the time interval between the time point t6 and the time point t7. The front wheel steering angular velocity ω becomes positive during the time intervals between the time point t2 and the time point t3, and between the time point t6 and the time point t7, and becomes negative during the time interval between the time point t4 and the time point t5. During the time periods between the time point t2 and the time point t3, between the time point t4 and the time point t5, and between the time point t6 to time point t7, the control lateral acceleration Gy before filtering (without filtering), the control lateral acceleration Gy after filtering (with filtering), and the conventional model lateral acceleration Gyc start changing in this order.

A similar behavior can be observed during the time interval between the time point t10 and the time point t17 as that observed during the time interval between the time point t2 and the time point t7. However, the steering angle information (the front wheel steering angle δ acquired by the front wheel steering angle sensor 34 and the front wheel steering angular velocity ω acquired by the front wheel steering angular velocity sensor 35) failed to be inputted from the sensors to the control device 31 at the time point t16, and is inputted only at the time point t17. In this manner, when the steering angle information is temporarily lost (failure to update the information occurs), the control device 31 retains the immediately preceding steering angle information (at the time point t15) (the steering angle information of the previous control cycle), and the steering angle information is used thereafter (at the time point t16) (in the current control cycle). Therefore, in appearance, the steering angle information does not change from the time point t15 to the time point t16, and changes somewhat more significantly than the actual change that may have taken place from the time point t16 to the time point t17.

As described above, the control lateral acceleration arithmetic calculation unit 49 uses the front wheel steering angle δ acquired from the front wheel steering angle sensor 34 and the front wheel steering angular velocity ω acquired from the front wheel steering angular velocity sensor 35 to calculate the control lateral acceleration Gy. Therefore, the control lateral acceleration Gy also does not change from the time point t15 to the time point t16, and changes slightly more significantly than the actual change from the time point t16 to the time point t17.

In the example for comparison shown in FIG. 6, the front wheel steering angular velocity ω obtained by time differentiating the front wheel steering angle δ, and the control lateral acceleration Gy obtained from this front wheel steering angular velocity ω and the front wheel steering angle δ are indicated by dotted lines (during the time intervals between the time point t15 and the time point t16). In this case, from the time point t15 to the time point t16, the control device 31 holds the value of the front wheel steering angle δ, and since the front wheel steering angle δ does not change, the front wheel steering angular velocity ω becomes 0. From the time point t16 to the time point t17, the front wheel steering angle δ changes significantly from the held value so that the front wheel steering angular velocity ω sharply increases, and then returns to the actual value. In this way, the front wheel steering angular velocity ω calculated by the time differentiation changes sharply in an oscillatory manner, and the control lateral acceleration Gy calculated by using this sharply changing front wheel steering angular velocity ω also changes sharply.

In the present embodiment, since the control lateral acceleration calculation unit 41 uses the front wheel steering angular velocity ω acquired from the front wheel steering angular velocity sensor 35, instead of the time differentiated value of the front wheel steering angle δ, to calculate the control lateral acceleration Gy, the formula in Equation (1) for calculating the control lateral acceleration may consist of a relatively low order formula. As a result, the change in the front wheel steering angular velocity ω is suppressed, and any discontinuity (sudden change) of the control lateral acceleration Gy due to the information discontinuity is alleviated.

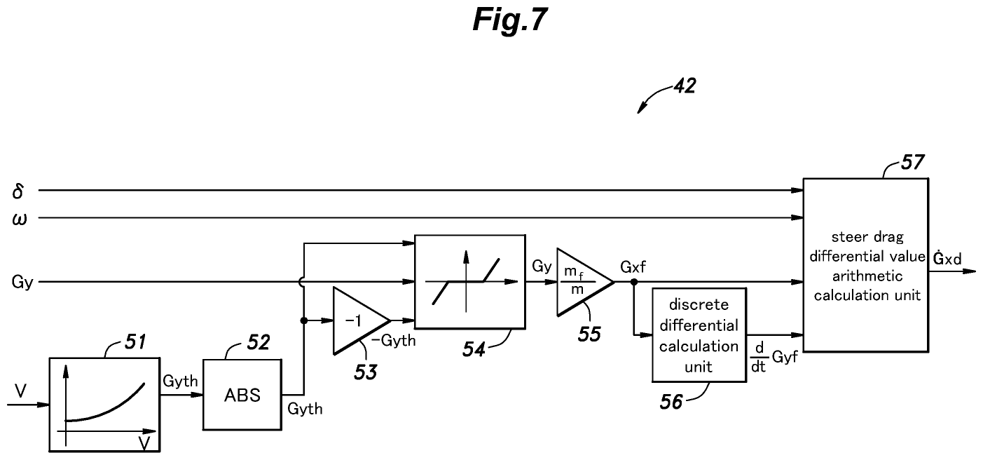

FIG. 7 is a functional block diagram of the steer drag differential value calculation unit 42. As shown in FIG. 7, the steer drag differential value calculation unit 42 includes a dead zone threshold value setting unit 51, an absolute value calculation unit 52, a negative value calculation unit 53, a dead zone processing unit 54, a control lateral acceleration front wheel component calculation unit 55, a discrete differential calculation unit 56, and a steer drag differential value arithmetic calculation unit 57.

The dead zone threshold value setting unit 51 sets a threshold Gyth to be used for the dead zone process for the control lateral acceleration Gy according to the vehicle speed V. More specifically, the dead zone threshold value setting unit 51 sets the threshold value Gyth to a positive value which gets larger with a higher vehicle speed V. The absolute value calculation unit 52 calculates the absolute value of the threshold value Gyth set by the dead zone threshold value setting unit 51. Since the dead zone threshold value setting unit 51 sets a positive value to the threshold value Gyth, the absolute value calculation unit 52 outputs the threshold value Gyth as it is. The negative value calculation unit 53 multiplies the threshold value Gyth by −1 to convert the threshold value Gyth to a negative value, and outputs the converted negative value threshold value −Gyth.

The dead zone processing unit 54 performs a dead zone process on the control lateral acceleration Gy by using the positive threshold value Gyth and the negative value threshold value −Gyth. More specifically, when the absolute value of the inputted control lateral acceleration Gy is equal to or less than the threshold value Gyth (|Gy|≤Gyth), the dead zone processing unit 54 outputs 0 as the control lateral acceleration Gy as the dead zone process, and when the absolute value of the inputted control lateral acceleration Gy is larger than the threshold value Gyth Gy Gyth), the absolute value of the control lateral acceleration Gy is reduced by the threshold value Gyth, and this reduced value is outputted as the control lateral acceleration Gy as the dead zone processing.

By performing the dead zone process in this way, the dead zone processing unit 54 outputs 0 as the control lateral acceleration Gy in the dead zone region where the absolute value is equal to or less than the predetermined threshold value Gyth. Therefore, in the dead zone region, no additional deceleration Gxadd is generated so that the vehicle behavior is the same as that of the base vehicle on which the vehicle control system 30 is mounted. Therefore, in the range of the front wheel steering angle δ where the vehicle travels substantially straight ahead (the dead zone region), the steering reaction force is the same as that of the base vehicle, and the vehicle 1 maintains the same responsiveness as the base vehicle. In this operating condition, since the frequency of occurrence of the additional braking force Fbadd decreases, the decrease in the durability of the brake system 22 and the brake lamp is not adversely affected. Further, in the operating range corresponding to this control dead zone, since the additional braking force Fbadd does not act on the vehicle 1 in the range where the front wheel steering angle δ is small, the operation of the vehicle control system 30 is prevented from interfering with the operation of other functional devices that are configured to operate when the vehicle travels straight ahead. On the other hand, when the control lateral acceleration Gy starts exceeding the predetermined threshold value Gyth, the control lateral acceleration is outputted as a continuous value increasing from 0 following the dead zone process. Therefore, the additional deceleration Gxadd increases gradually so that the cornering performance of the vehicle 1 can be improved while maintaining a smooth vehicle behavior.

The control lateral acceleration front wheel component calculation unit 55 multiplies the control lateral acceleration Gy which has been subjected to the dead zone processing by a front axle mass ratio mf/m (which is the ratio of the front axle mass mf to the vehicle mass m) to calculate a control lateral acceleration front wheel component Gyf which is the front wheel component of the control lateral acceleration Gy. The discrete differential calculation unit 56 differentiates the control lateral acceleration front wheel component Gyf to calculate the control lateral acceleration front wheel component differential value d/dt Gyf. The steer drag differential value arithmetic calculation unit 57 calculates the steer drag differential value d/dt GxD (=d/dt (Gyf·δ)), which is the differential value of the steer drag GxD (=Gyf·δ), from the front wheel steering angle δ, the front wheel steering angular velocity ω, the control lateral acceleration front wheel component Gyf and the control lateral acceleration front wheel component differential value d/dt Gyf by using Equation (2) given in the following.

$$\frac{d}{dt} ( {G}_{yf} \cdot δ ) = \frac{d}{dt} ( {G}_{yf} ) \cdot δ + {G}_{yf} \cdot \dot{δ} \qquad ( 12 )$$

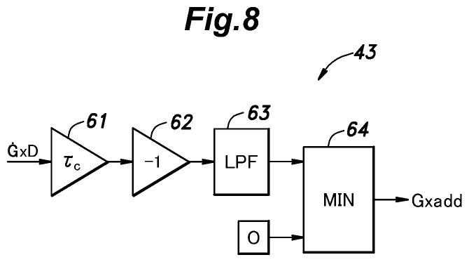

FIG. 8 is a functional block diagram of the additional deceleration calculation unit 43. As shown in FIG. 8, the additional deceleration calculation unit 43 includes an advance time constant multiplication unit 61, a negative value calculation unit 62, an LPF 63 (low-pass filter), and a low value selection unit 64.

The advance time constant multiplication unit 61 multiplies the steer drag differential value d/dt GxD by the advance time constant τc. As a result, the magnitude of the steer drag differential value d/dt GxD, which is the basis for calculating the additional deceleration Gxadd shown in FIG. 3, is changed so that the degree of phase advance with respect to the deceleration of the steer drag of the total deceleration is adjusted. The negative value calculation unit 62 converts the product of the steer drag differential value d/dt GxD and the advance time constant τc into a negative value by multiplying −1 to the product so that the fore and aft acceleration generated in the vehicle 1 becomes a negative value (deceleration). The LPF 63 performs a low-pass filter process on the value converted into a negative value by the negative value calculation unit 62. As a result, the increase in the high frequency gain is suppressed so that the fluctuations of the additional deceleration Gxadd in the high frequency region is suppressed, and noise is removed. The low value selection unit 64 compares the value output from the LPF 63 with 0, selects a lower value to be outputted as the additional deceleration Gxadd. The additional deceleration Gxadd outputted from the low value selection unit 64 is a value equal to or smaller than 0.

As shown in FIG. 2, the additional deceleration Gxadd output that is outputted from the additional deceleration calculation unit 43 is subjected to an appropriate correction process by the additional deceleration correction unit 44. The corrected additional deceleration Gxadd that is outputted from the additional deceleration correction unit 44 is used by the additional braking force calculation unit 45 to calculate the additional braking force Fbadd. The additional braking force calculation unit 45 outputs the calculated additional braking force Fbadd when the control permission flag F is 1, and does not output the calculated additional braking force Fbadd when the control permission flag F is 0. The control device 31 adds the additional braking force Fbadd output from the additional braking force calculation unit 45 to the target braking force Fbt, and causes the power plant 6 and/or the brake system 22 to generate the combined target braking force to which the additional braking force Fbadd is added. As a result, as shown in FIG. 3, a deceleration given as a combination of the additional deceleration Gxadd and the deceleration due to the steer drag is generated in the vehicle 1 so that the cornering performance of the vehicle 1 is improved.

When calculating the additional braking force Fbadd, the additional braking force calculation unit 45 calculates at least a part of the additional braking force Fbadd as a command for the brake system 22. Therefore, even when the vehicle operator is not depressing the accelerator pedal, the brake system 22 applies the additional braking force Fbadd to the vehicle 1 with a high responsiveness.

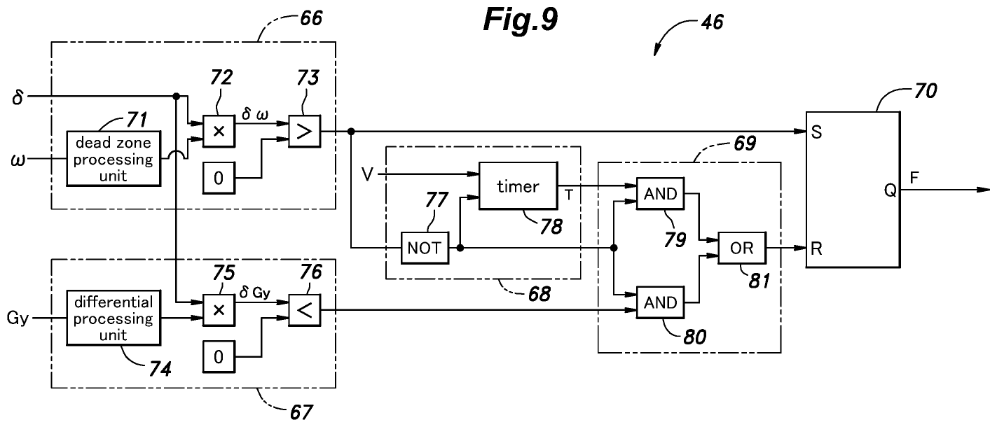

FIG. 9 is a functional block diagram of the control permission determination unit 46. As shown in FIG. 9, the control permission determination unit 46 includes a first determination unit 66, a second determination unit 67, an extension time elapsing determination unit 68, a permission flag reset determination unit 69, and a latching processing unit 70.

The first determination unit 66 includes a dead zone processing unit 71 that performs a dead zone process on the front wheel steering angular velocity ω, a first multiplier 72 that multiplies the output of the dead zone processing unit 71 (the front wheel steering angular velocity ω which has been dead zone processed) to the front wheel steering angle δ to produce a first value δ·ω, and a first comparator 73 that compares the first value δ·ω with 0. The first comparator 73 outputs 1 when the first value δ·ω is larger than 0, or when the first value δ·ω is positive, and outputs 0 when the first value δ·ω is equal to 0 or smaller, or when the first value δ·ω is not positive. When the output of the first determination unit 66 is 1, it means that the front wheel 4A is being steered (so as to cause the steering angle δ to increase in either direction or in absolute value). When the output of the first determination unit 66 is 0, it means that the front wheel 4A is not steered or is being steered back (so as to cause steering angle δ to decrease in absolute value or come closer to zero angle).

The second determination unit 67 includes a differential processing unit 74 that differentiates the control lateral acceleration Gy, a second multiplier 75 that multiplies the output of the differential processing unit 74 (a differential value d/dt Gy of the control lateral acceleration Gy) to the front wheel steering angle δ to produce a second value (δ·d/dt Gy), and a second comparator 76 compares the second value with 0. The second comparator 76 outputs 1 when the second value (δ·d/dt Gy) is smaller than 0, or when the second value (δ·d/dt Gy) is negative, and outputs 0 when the second value (δ·d/dt Gy) is equal to or greater than 0, or when the second value is not negative. When the output of the second determination unit 67 is 1, it means that the changing directions of the front wheel steering angle δ and the control lateral acceleration Gy do not agree with each other (opposite to each other). When the output of the second determination unit 67 is 0, it means that the changing directions of the front wheel steering angle δ and the control lateral acceleration Gy coincide with each other, or at least one of them is 0.

The extension time elapsing determination unit 68 includes a NOT circuit 77 (inverter circuit) that receives the output of the first determination unit 66, and a timer 78. The NOT circuit 77 outputs a value (0 or 1) opposite to the output (1 or 0) of the first determination unit 66. The timer 78 sets an extension time T or an extension time period by which the additional deceleration control is extended according to the vehicle speed V. More specifically, the timer 78 is activated when the output of the NOT circuit 77 changes from 0 to 1, and times out or outputs 1 upon elapsing of the extension time T therefrom. When the output of the NOT circuit 77 changes from 0 to 1, it means that the output of the first determination unit 66 has changed from 1 to 0, or the steering of the front wheels 4A (in a direction to increase the absolute value of the front wheel steering angle δ) has been concluded. The extension time T of the timer 78 becomes longer with an increase in the vehicle speed V.

The permission flag reset determination unit 69 includes a first AND circuit 79 and a second AND circuit 80 which are connected in parallel to each other, and an OR circuit 81 which is connected to the output ends of these two circuits in series. The output of the timer 78 and the output of the NOT circuit 77 are inputted to the first AND circuit 79 so that the first AND circuit 79 outputs 1 when the inputs are both 1 and otherwise outputs 0. The output of the NOT circuit 77 and the output of the second determination unit 67 are inputted to the second AND circuit 80, and the second AND circuit 80 outputs 1 when the inputs are both are 1, and otherwise outputs 0. The output of the first AND circuit 79 and the output of the second AND circuit 80 are inputted to the OR circuit 81 so that the OR circuit 81 outputs 1 when at least one of the inputs is 1, and 0 when the inputs are both 0.

Thus, when the first value δ·ω is not positive (when the front wheel steering angle δ is kept fixed or when the front wheel steering angle δ is being reduced in absolute value), and a predetermined extension time T has elapsed since the front wheel steering angle δ has ceased to increase in absolute value, the output of the first AND circuit 79 becomes 1. When the first value δ·ω is not positive (when the front wheel steering angle δ is kept fixed or when the front wheel steering angle δ is being reduced in absolute value), and the changing directions of the front wheel steering angle δ and the control lateral acceleration Gy do not agree with each other, the output of the second AND circuit 80 becomes 1. When the output of at least one of the first AND circuit 79 and the second AND circuit 80 is 1, the output of the OR circuit 81 becomes 1.

The latching processing unit 70 is provided with an S input which receives the output from the first determination unit 66 and an R input which receives the output from permission flag reset determination unit 69. The latching processing unit 70 outputs a control permission flag F which is either 0 or 1 from a Q output thereof according to the truth table (Table 1) given below.

TABLE 1

| | |
|---|---|
| input | output |

| S | R | Q | |
|---|---|---|---|
| 0 | 0 | 1 | (hold) |
| 0 | 1 | 0 | |
| 1 | 0 | 1 | |
| 1 | 1 | 0 | (not allowed) |

As shown in Table 1, when the S input is 1 while the R input is 0, the latching processing unit 70 outputs 1 (control permission) as the Q output. In other words, when the first value δ·ω is positive (the front wheel steering angle δ is increasing in absolute value), and the directions of changes in the front wheel steering angle δ and the control lateral acceleration Gy coincide with each other or at least one of them is 0, the control permission flag F is set to 1. Further, when the S input becomes 0 while the R input is 0, the latching processing unit 70 continues to output 1 (hold or control permission) at the Q output. In other words, even when the first value δ·ω changes from a positive value to a non-positive value (zero or negative value), in the case where the predetermined extension time has not elapsed from cessation of the increase in the front wheel steering angle δ in absolute value, and the changing directions of the front wheel steering angle δ and the control lateral acceleration Gy coincide with each other (or at least one of the front wheel steering angle δ and the control lateral acceleration Gy is zero), the control permission flag F continues to be set to 1.

As a result, the additional deceleration control is permitted only when the front wheels 4A are being steered by the driver's steering operation (the front when steering angle δ is increasing in absolute value), and the steer drag GxD is changing in magnitude. Therefore, the additional deceleration control is prevented from being permitted when the steer drag GxD is increasing due to such events as accelerating the vehicle while the front wheels 4A are held at a fixed steering angle δ and the reversal or overshoot of the control lateral acceleration Gy while the front wheel steering angle δ is being decreased in absolute value.

The effect of the control device 31 executing the additional deceleration control according to the result of the control permission determination process performed by the control permission determination unit 46 is described in the following.

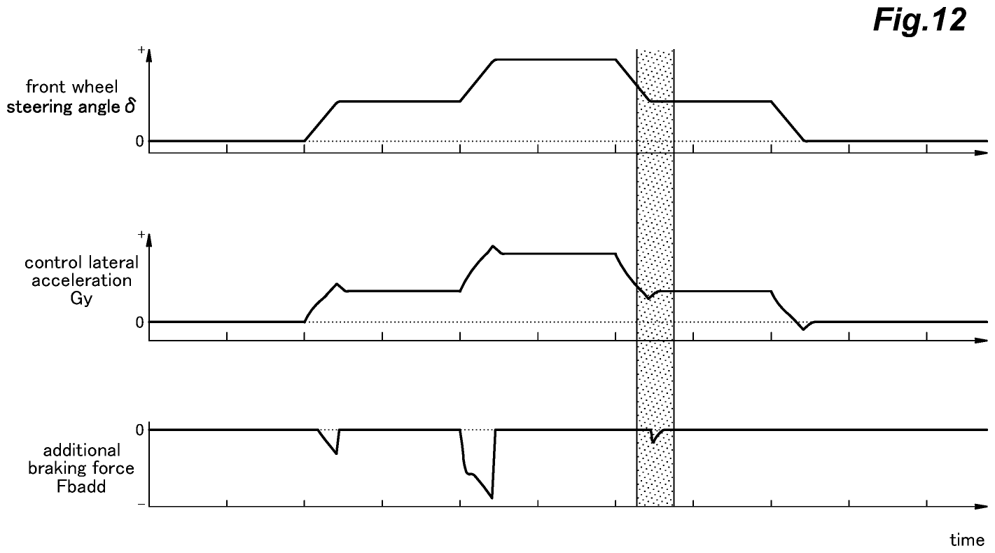

FIG. 12 is a time chart showing changes in various parameters during a low-speed traveling condition under the additional deceleration control of the example for comparison. In this example, the control device 31 does not include the control permission determination unit 46 (FIG. 2), and constantly outputs the additional braking force Fbadd (additional braking torque) calculated by the additional braking force calculation unit 45 (FIG. 2). In this case, as shown in the shaded area of FIG. 12, when the front wheel steering angle δ is decreased in absolute value and then held at a constant value, the control lateral acceleration Gy overshoots so that an additional braking force Fbadd is generated due to this steering operation.

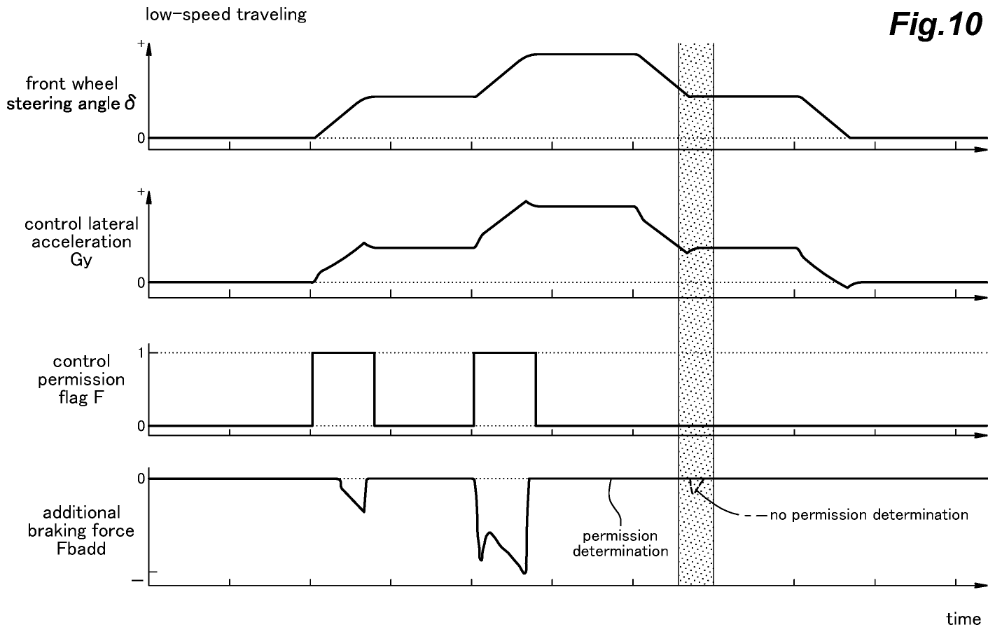

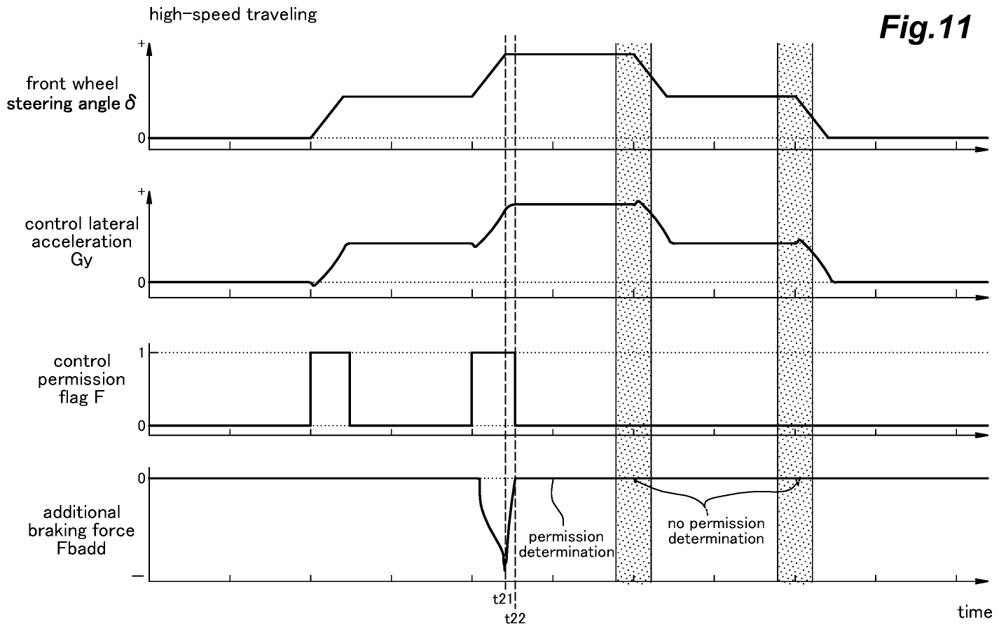

FIG. 10 is a time chart showing changes in various parameters during a low-speed traveling condition under the additional deceleration control according to the present embodiment, and FIG. 11 is a time chart showing changes in various parameters during a high-speed traveling condition under the additional deceleration control according to the present embodiment. In the present embodiment, when the first value δ·ω obtained by multiplying the front wheel steering angle δ to the front wheel steering angular velocity ω is positive (δ·ω>0), the control permission determination unit 46 permits the additional deceleration control. On the other hand, in the state shown by the shaded area in FIG, 10 and FIG. 11, the control permission determination unit 46 prohibits the additional deceleration control. Therefore, in the shaded area, the additional braking force Fbadd is calculated by the additional braking force calculation unit 45 as a value less than 0 as shown by the broken line, but is not outputted. As a result, the generation of unnecessary additional deceleration Gxadd is suppressed.

Further, as described above, the additional braking force calculation unit 45 calculates at least a part of the additional braking force Fbadd as a command for the brake system 22. Therefore, the durability of the brake system 22 is improved by avoiding frequent use of the brake system 22 by prohibiting the generation of the additional deceleration Gxadd as a result of an unnecessary control intervention when the front wheel steering angle δ is being decreased in absolute value.

On the other hand, as shown in FIG. 11, the control lateral acceleration Gy may continue to increase even after the time point t21 at which the increase in the absolute value of the front wheel steering angle δ has ceased. Such a delay of the control lateral acceleration Gy with respect to the front wheel steering angle δ tends to increase with an increase in the vehicle speed V. While the control lateral acceleration Gy is increasing, the steer drug GxD given as a rearward component thereof continues to increase. Therefore, even after the time point t21 at which the increase in the absolute value of the front wheel steering angle δ has ceased, the additional braking force Fbadd is calculated as a value less than 0 by the additional braking force calculation unit 45. As a result, the vehicle attitude may not be stabilized.

However, in the present embodiment, the control permission determination unit 46 selectively permits the additional deceleration control or determines if the additional deceleration control is to be permitted or not. More specifically, the first determination unit 66 (FIG. 9) of the control permission determination unit 46 outputs 0 when the first value δ·ω obtained by multiplying the front wheel steering angle δ to the front wheel steering angular velocity ω is 0 or less, or when the front wheel steering angle is fixed in value or is decreasing in absolute value. As a result, the control permission determination unit 46 prohibits the additional deceleration control at the time point t21 in FIG. 11 with the result that the additional braking force Fbadd is not outputted even when the additional braking force Fbadd is calculated as a value smaller than 0, and the vehicle attitude is stabilized.

In the present embodiment, even when the first value δ·ω obtained by multiplying the front wheel steering angle δ to the front wheel steering angular velocity ω is not positive (δ·ω≤0), in the event that the product of the front wheel steering angle δ and the differential value d/dt Gy of the control lateral acceleration Gy is not negative (δ·d/dt Gy≥0), since the S input and the R input in Table 1 become both 0, the Q output is maintained at 1, and the control permission determination unit 46 (FIG. 9) continues to permit the additional deceleration control. As a result, as shown in FIG. 11, even after the time point t21 at which the front wheel steering angle δ becomes constant following an increase in the absolute value of the front wheel steering angle δ, the permission for the additional deceleration control is extended until the time point t22 at which the increase in the control lateral acceleration Gy ceases. Thereby, the vehicle attitude is stabilized.

As shown in FIG. 9, Suppose a situation where the control permission determination unit 46 maintains or continues to permit the additional deceleration control because the second value δ·d/dt Gy obtained by multiplying the front wheel steering angle δ to the differential value δ·d/dt Gy is positive after the first value δ·ω obtained by multiplying the front wheel steering angle δ to the front wheel steering angular velocity ω has changed from being positive to being not positive (zero or negative). In this situation, the additional deceleration control is prohibited upon elapsing of the extension time T, which is a pre-determined time period depending on the vehicle speed, from the time point at which the first value changed from being positive to being not positive. The control device 31 of the present embodiment permits to continue the additional deceleration control only for the duration of the extension time T, which is determined by the vehicle speed, following the ceasing of the increase in the absolute value of the front wheel steering angle δ so as to correspond to the tendency of the delay of the increase in the control lateral acceleration Gy in response to an increase in the absolute value of the front wheel steering angle δ.

As described above, the delay in the increase in the control lateral acceleration Gy with respect to the increase in the front wheel steering angle δ increases as the vehicle speed V increases. In the present embodiment, since the extension time T is selected to be longer as the vehicle speed V becomes higher, so that the vehicle attitude can be further stabilized.

Even when the vehicle 1 is traveling straight ahead or in a steady cornering, the front wheel steering angular velocity ω may fluctuate slightly due to road surface irregularities and other causes. In such a case, if the control permission determination unit 46 (FIG. 9) determines if the additional deceleration control is to be permitted or not by using the front wheel steering angular velocity ω as it is, the determination result may excessively fluctuate. According to the present embodiment, the control permission determination unit 46 determines the permission of the additional deceleration control by using a processed value of the processed front wheel steering angular velocity ω obtained by performing a dead zone process on the front wheel steering angular velocity ω. Therefore, the additional deceleration control is prevented from being unnecessarily permitted under a condition that does not require the additional deceleration control such as a straight ahead traveling condition and a steady cornering condition.

Further, as shown in FIGS. 2 and 8, the additional deceleration calculation unit 43 calculates the additional deceleration Gxadd based on the steer drag differential value d/dt Gy. Therefore, the control device 31 generates Gxadd based on the steer drag differential value d/dt GxD when the control lateral acceleration Gy and the steer drag GxD are increasing following the time point t21 at which the front wheel steering angle δ becomes constant as shown in FIG. 11 with the result that the transfer of the load of the vehicle 1 to the front wheels 4A is performed in an appropriate manner, and the attitude of the vehicle 1 can be stabilized.

The present invention has been described in terms of a specific embodiment, but is not limited by such an embodiment, and can be modified and substituted in various ways without departing from the scope of the present invention. For instance, the specific configurations and arrangements of each member or portion, quantity, angle, calculation formula, etc. can be appropriately changed within the scope of the present invention. Further, the components shown in the above embodiments are not entirely indispensable, but can be appropriately selected, omitted, and substituted.

1. A vehicle control system, comprising:
a braking force generator that generates a braking force that acts on a vehicle;
a control device that controls the braking force generated by the braking force generator; and
a vehicle state information acquisition device that acquires vehicle state information including a steering angle of a front wheel, a steering angular velocity of the front wheel, and a lateral acceleration of the vehicle,
wherein the control device includes
an additional deceleration calculation unit that calculates an additional deceleration to be applied to the vehicle according to the vehicle state information,
an additional braking force calculation unit that calculates an additional braking force to be generated by the braking force generator according to the additional deceleration, and
a control permission determination unit that selectively permits an additional deceleration control that commands the braking force generator to generate the additional braking force at least according to the steering angle, the steering angular velocity, and the lateral acceleration, the control permission determination unit permitting the additional deceleration control when a product of the steering angle and the steering angular velocity is a positive value,
wherein even when the product of the steering angle and the steering angular velocity is not a positive value, the control permission determination unit permits the additional deceleration control when a product of the steering angle and a differential value of the lateral acceleration is not negative in value.

2. The vehicle control system according to claim 1, wherein when the additional deceleration control continues to be permitted because the product of the steering angle and the differential value of the lateral acceleration is positive in value following an event where the product of the steering angle and the steering angular velocity changes from being positive in value to being not positive in value, the control permission determination unit prohibits the additional deceleration control upon elapsing of a prescribed extension time depending on a vehicle speed from a time point at which the product of the steering angle and the steering angular velocity changes from being positive in value to being not positive in value.

3. The vehicle control system according to claim 2, wherein the extension time becomes longer with an increase in the vehicle speed.

4. The vehicle control system according to claim 1, wherein the control permission determination unit selectively permits the additional deceleration control according to the steering angular velocity which is subjected to a dead zone process.

5. The vehicle control system according to claim 1, wherein the control device further comprises a steer drag differential value calculation unit that calculates a steer drag differential value by differentiating a steer drag value obtained from the vehicle state information as a rearward directed component of a lateral force of the front wheel of the vehicle, and the additional deceleration calculation unit calculates the additional deceleration according to the steer drag differential value.

6. The vehicle control system according to claim 5, wherein the vehicle state information acquisition device further comprises a velocity sensor that detects an angular velocity or a velocity corresponding to the steering angular velocity, and the control device further comprises a control lateral acceleration calculation unit that calculates a control lateral acceleration by using at least the steering angular velocity, the additional deceleration calculation unit calculating the steer drag differential value by using the control lateral acceleration.

7. The vehicle control system according to claim 1, wherein the braking force generator includes a brake device, and the additional braking force calculation unit calculates at least a part of the additional braking force to be commanded to the brake device.
